(19) United States
(12) Patent Application Publication
(10) Pub. No.: US 2023/0289621 A1
(43) Pub. Date: Sep. 14, 2023

(54) AUTOMATIC GENERATION OF KNOWLEDGE GRAPHS

(71) Applicant: UiPath, Inc., New York, NY (US)

(72) Inventors: Palak KADAKIA, Redmond, WA (US); Matthew VANDERZEE, Sammamish, WA (US); Ankit SARAF, Bellevue, WA (US); Paramjit Singh KAHLON, Clyde Hill, WA (US)

(73) Assignee: UiPath, Inc., New York, NY (US)

(21) Appl. No.: 17/654,785

(22) Filed: Mar. 14, 2022

(51) Int. Cl. G06N 5/02; G06F 40/30; G06F 40/295

(52) U.S. Cl. CPC G06N 5/022; G06F 40/30; G06F 40/295

(57) ABSTRACT

Systems and methods for automatically generating a knowledge graph are provided. Entity data, process data, user data, and system data of an organization are extracted from one or more business data sources. A knowledge graph defining relationships between the entities data, the process data, the user data, and the system data is generated. The knowledge graph is output.

### TECHNICAL FIELD

The present invention relates generally to automatic generation of knowledge graphs, and more particularly to automatic generation of knowledge graphs to depict how processes, systems, people, and entities relate.

### BACKGROUND

Knowledge graphs are graph-structured data models for integrating and interrelating data. Conventionally, knowledge graphs in the process space are manually generated by users defining relationships between data. However, such conventionally generated knowledge graphs are static and are unable to be automatically updated as the data changes.

### BRIEF SUMMARY OF THE INVENTION

In accordance with one or more embodiments, systems and methods for automatically generating a knowledge graph are provided. Entity data, process data, user data, and system data of an organization are extracted from one or more business data sources. A knowledge graph defining relationships between the entities data, the process data, the user data, and the system data is generated. The knowledge graph is output.

In one embodiment, the entity data may be extracted from the one or more business data sources by performing semantic meaning extraction of entities of the organization. The process data may be extracted from the one or more business data sources by performing at least one of process mining, task mining, task capture, or process capture to identify processes defining how entities of the organization interact with each other. The processes may be RPA (robotic process automation) processes executed by one or more RPA robots. The user data may be extracted from the one or more business data sources by performing at least one of process mining, tasking mining, or task capture to determine how individuals of the organization interact with entities of the organization. The system data may be extracted from the one or more business data sources by performing at least one of process mining or process capture to determine a relationship between systems of the organization and entities of the organization.

In one embodiment, changes of the entity data, the process data, the user data, and the system data are tracked. The knowledge graph is updated based on the tracked changes.

In one embodiment, the extracting, the generating, and the outputting steps are repeated for a plurality of organizations to generate a plurality to knowledge graphs. An optimized knowledge graph is generated based on the knowledge graph and the plurality of knowledge graphs. In one embodiment, one or more standardized processes for the organization and the plurality of organizations may be created based on the optimized knowledge graph. In another embodiment, one or more best practices processes are extracted from the optimized knowledge graph and the one or more best practices processes are stored in a library.

These and other advantages of the invention will be apparent to those of ordinary skill in the art by reference to the following detailed description and the accompanying drawings.

### BRIEF DESCRIPTION OF THE DRAWINGS

FIG. 1 shows a method for automatically generating a knowledge graph, in accordance with one or more embodiments; and

FIG. 2 is a block diagram of a computing system according to an embodiment of the invention.

### DETAILED DESCRIPTION

Embodiments described herein provide for the automatic generation of knowledge graphs. Knowledge graphs are graph-structured data models for integrating and interrelating data such as, e.g., processes, systems, individuals, and entities. Such knowledge graphs describe how the processes, systems, individuals, and entities relate with each other. Advantageously, embodiments described herein track changes to the interaction of the processes, systems, people, and entities via continuous discovery to maintain and update the knowledge graphs.

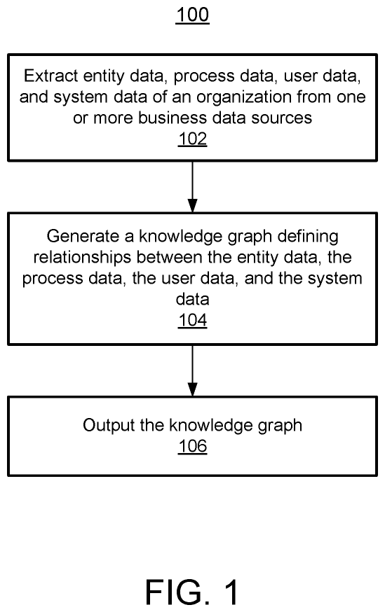

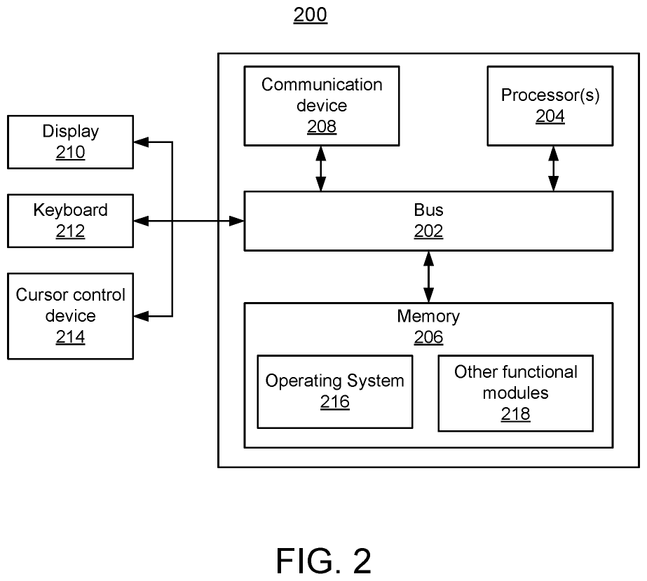

FIG. 1 shows a method 100 for automatically generating a knowledge graph, in accordance with one or more embodiments. The steps of method 100 may be performed by any suitable computing device, such as, e.g., computing system 200 of FIG. 2.

At step 102, entity data, process data, user data, and system data of an organization are extracted from one or more business data sources. The one or more business data sources may comprise any suitable data source, such as, e.g., databases, CV (computer vision), DU (document understanding), images, user (e.g., expert or practitioner) provided inputs (e.g., process diagrams or task captures), robot (e.g., RPA (robotic process automation) robot) logs, robot process definition files, etc. The organization may comprise any entity, such as, e.g., a corporation, a company, etc.

The entity data comprises data flowing through or used by systems of the organization, such as, e.g., purchase orders, cases, patients, suppliers, products, etc. and their records. In one embodiment, the entity data may be extracted from the business data sources by semantic meaning extraction of entities of the organization to identify attributes and relationships. Semantic meaning extraction may be performed by extracting an object model from the underlying systems, relating the object model to a standardized object model, and mapping concepts of the object model that match.

The process data comprises data relating to processes utilized in the organization for various organizational needs, such as, e.g., purchase-to-pay, hire-to-retire, order-to-cash, etc. The process data may be extracted from the business data sources by one or more of process mining, task mining, task capture, or process capture to identify processes defining how the entities interact with each other. In one embodiment, the processes are RPA processes automatically executed by one or more RPA robots.

The user data comprises data identifying users in the organization and their attributes and relationships. For example, the user data may identify Joe as being the procurement manager, who reports to John and works closely with Jane from the accounts team. The user data may be extracted from the business data sources by one or more of process mining, task mining, or task capture to determine how individuals of the organization interact with the entities.

The system data comprises data relating to systems utilized in the organization and their purpose. The system data may be extracted from the business data sources by one or more of process mining or process capture to determine the relationship between systems of the organization and the entities of the organization.

As used herein, process mining refers to the automatic identification of processes (e.g., RPA processes) by monitoring enterprise systems for tracking relationships between events. Task mining refers to the automatic identification of tasks (e.g., RPA tasks) by observing (e.g., real time or near real time monitoring or offline analysis) user interaction (e.g., explicit user input or inferred user activity) on applications. Process capture (also referred to as process discovery or process modeling) refers to designing enterprise processes based on user input (e.g., explicit user input or inferred user activity). Task capture refers to the identification of tasks based on user input. Other discovery techniques may be performed for extracting the entity data, process data, user data, and/or system data.

In one example, consider an “order fulfillment” process. The business data sources comprise the purchasing system, the invoicing system, and the sales system. The individuals involved are the sales person, the accounting team member, etc. The entities are the order object, the invoice object, etc. A knowledge graph may be generated by interrelating this order fulfillment process with other adjacent processes (e.g., order purchase, etc.).

At step 104, a knowledge graph defining relationships between the entity data, the process data, the user data, and the system data is generated. Once entities are identified from the entity data, the process data, the user data, and the system data are extracted and semantic meaning is ascribed to them, the events, activities and other attributes and relationships are connected to form relationships therebetween. The idea is to understand who, what, how, and where the interactions between the entities are happening.

In one example, if John interacts with cases 100 times a week and a product 2 times a week, an edge may be added from John to the cases and the product with respective weights of 100 and 2 and edges from John and the cases to the respective systems where those interactions took place. Additionally, John may have sent 30 cases to Joe and therefore an edge is added between John and Joe. Performing such an exercise at scale across all entities will result in a highly interconnected graph with different weights. The graph can be trimmed at visual level by defining a minimum weight for which edges are shown.

At step 106, the knowledge graph is output. For example, the knowledge graph may be output by displaying the knowledge graph on a display device of a computer system, storing the knowledge graph on a memory or storage of a computer system, or by transmitting the knowledge graph to a remote computer system.

In one embodiment, continuous discovery may be performed to track the changes of the entity data, the process data, the user data, and the system data. The tracked changes represent changes in the interaction of individuals to entities, robots (e.g., RPA robots) to entities, entities to other entities, and systems to entities over time. The tracked changes may be used to continuously update the knowledge graph. In one embodiment, continuous discovery is performed by interpreting new events as they happen, either in a streaming fashion or in batches. These new events can be compared against the knowledge graph to determine if they match the current state of the knowledge graph, i.e. they conform to an existing node in the knowledge graph. If they do, the knowledge graph metadata (event counts, edge weightings, etc.) can be updated to reflect the new event. If they do not, business logic can be applied to determine whether this is an exception to the process and remediation should take place, or whether the knowledge graph should be updated to reflect this new information. Knowledge graph updating can be performed either by reprocessing all of the available data, or by incrementally evolving the knowledge graph according to the new data.

In one embodiment, a knowledge graph for each of a plurality of organizations may be generated by repeatedly performing the steps of method 100. The knowledge graph of the organization and the knowledge graphs of the plurality of organizations may be used to generate an optimized knowledge graph. The optimized knowledge graph could be formed in various ways. In one example, the optimized knowledge graph is generated by mean averaging the knowledge graph of the organization and the knowledge graphs of the plurality of organizations. If the “personal” data is removed from the knowledge graphs and replaced with their semantic equivalents, the resulting knowledge graph are similar across the organizations. In some cases, the nodes may differ a little or edges may have different weights, but they will be similar to each other. The most common nodes and edges among the knowledge graphs are identified to generate an average or standardized graph. Mathematically, each node and edge is denoted as n1 . . . nN and (n1, n2, w) respectively. As they have already been converted to their semantic equivalent, it is possible to mean average the nodes that should exist in the standardized graph and similarly for edges. In another embodiment, the optimized knowledge graph is generated by applying clustering algorithms to identify typical steps in a standardized process. Algorithms that compute the optimized knowledge graph may factor in any or all of the data in any of the knowledge graphs: step names, edge frequency, business system data, business metadata, etc. The optimized knowledge graph can be used to create standardized processes for the organization and the plurality of organizations. In another embodiment, process discovery data from the organization and the plurality of organizations may be used to create the standardized processes for the organization and the plurality of organizations. Standardized processes refer to industry- or vertical-specific processes that represent a common way of executing a certain business process. These standardized processes can then be used to compare a particular organization's process against the typical way for benchmarking purposes.

In one embodiment, best practices processes may be extracted from the optimized knowledge graph and stored in a library. The library may help new users starting a new organization. For example, order-to-cash, leads-to-order, HR (human resources) processes, onboarding processes, etc. can be extracted from the optimized knowledge graph. The extracted processes may be stored in a library to facilitate the starting of a new organization with best practices processes. Accordingly, the new organization may be created using the library of best practices processes, avoiding the need for the organization to build such a library from scratch. For example, by interpreting the knowledge graphs for invoice processing from a plurality of organizations, the system can identify a “best practices” way of processing an invoice. Factoring in various parameters of each organization's invoice processing knowledge graph (e.g., execution speed, number of people involved, success rate, etc.) and normalizing the graphs as above, the system can identify the optimized knowledge graph(s) over those parameters. The system would then be able to identify the delta between each organization's current knowledge graph and the best practices knowledge graph. This resulting delta would inform that organization as to what changes they would need to make to improve their process.

FIG. 2 is a block diagram illustrating a computing system 200 configured to execute the methods, workflows, and processes described herein, including method 100 of FIG. 1, according to an embodiment of the present invention. In some embodiments, computing system 200 may be one or more of the computing systems depicted and/or described herein. Computing system 200 includes a bus 202 or other communication mechanism for communicating information, and processor(s) 204 coupled to bus 202 for processing information. Processor(s) 204 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 204 may also have multiple processing cores, and at least some of the cores may be configured to perform specific functions. Multi-parallel processing may be used in some embodiments.

Computing system 200 further includes a memory 206 for storing information and instructions to be executed by processor(s) 204. Memory 206 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 204 and may include volatile media, non-volatile media, or both. The media may also be removable, non-removable, or both.

Additionally, computing system 200 includes a communication device 208, such as a transceiver, to provide access to a communications network via a wireless and/or wired connection according to any currently existing or future-implemented communications standard and/or protocol.

Processor(s) 204 are further coupled via bus 202 to a display 210 that is suitable for displaying information to a user. Display 210 may also be configured as a touch display and/or any suitable haptic I/O (input/output) device.

A keyboard 212 and a cursor control device 214, such as a computer mouse, a touchpad, etc., are further coupled to bus 202 to enable a user to interface with computing system. However, in certain embodiments, a physical keyboard and mouse may not be present, and the user may interact with the device solely through display 210 and/or a touchpad (not shown). Any type and combination of input devices may be used as a matter of design choice. In certain embodiments, no physical input device and/or display is present. For instance, the user may interact with computing system 200 remotely via another computing system in communication therewith, or computing system 200 may operate autonomously.

Memory 206 stores software modules that provide functionality when executed by processor(s) 204. The modules include an operating system 216 for computing system 200 and one or more additional functional modules 218 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A computer-implemented method comprising:
extracting entity data, process data, user data, and system data of an organization from one or more business data sources;
generating a knowledge graph defining relationships between the entities data, the process data, the user data, and the system data; and
outputting the knowledge graph.

2. The computer-implemented method of claim 1, wherein extracting entity data, process data, user data, and system data of an organization from one or more business data sources comprises:
extracting the entity data from the one or more business data sources by performing semantic meaning extraction of entities of the organization.

3. The computer-implemented method of claim 1, wherein extracting entity data, process data, user data, and system data of an organization from one or more business data sources comprises:
extracting the process data from the one or more business data sources by performing at least one of process mining, task mining, task capture, or process capture to identify processes defining how entities of the organization interact with each other.

4. The computer-implemented method of claim 3, wherein the processes are RPA (robotic process automation) processes executed at least in part by one or more RPA robots.

5. The computer-implemented method of claim 1, wherein extracting entity data, process data, user data, and system data of an organization from one or more business data sources comprises:
extracting the user data from the one or more business data sources by performing at least one of process mining, tasking mining, or task capture to determine how individuals of the organization interact with entities of the organization.

6. The computer-implemented method of claim 1, wherein extracting entity data, process data, user data, and system data of an organization from one or more business data sources comprises:
extracting the system data from the one or more business data sources by performing at least one of process mining or process capture to determine a relationship between systems of the organization and entities of the organization.

7. The computer-implemented method of claim 1, further comprising
tracking changes of the entity data, the process data, the user data, and the system data; and
updating the knowledge graph based on the tracked changes.

8. The computer-implemented method of claim 1, further comprising:
repeating the extracting, the generating, and the outputting for a plurality of organizations to generate a plurality to knowledge graphs; and
generating an optimized knowledge graph based on the knowledge graph and the plurality of knowledge graphs.

9. The computer-implemented method of claim 8, further comprising:
creating one or more standardized processes for the organization and the plurality of organizations based on the optimized knowledge graph.

10. The computer-implemented method of claim 8, further comprising:
extracting one or more best practices processes from the optimized knowledge graph; and
storing the one or more best practices processes in a library.

11. An apparatus comprising:
a memory storing computer instructions; and
at least one processor configured to execute the computer instructions, the computer instructions configured to cause the at least one processor to perform operations of:
extracting entity data, process data, user data, and system data of an organization from one or more business data sources;
generating a knowledge graph defining relationships between the entities data, the process data, the user data, and the system data; and
outputting the knowledge graph.

12. The apparatus of claim 11, wherein extracting entity data, process data, user data, and system data of an organization from one or more business data sources comprises:
extracting the entity data from the one or more business data sources by performing semantic meaning extraction of entities of the organization.

13. The apparatus of claim 11, wherein extracting entity data, process data, user data, and system data of an organization from one or more business data sources comprises:
extracting the process data from the one or more business data sources by performing at least one of process mining, task mining, task capture, or process capture to identify processes defining how entities of the organization interact with each other.

14. The apparatus of claim 13, wherein the processes are RPA (robotic process automation) processes executed at least in part by one or more RPA robots.

15. The apparatus of claim 11, wherein extracting entity data, process data, user data, and system data of an organization from one or more business data sources comprises:
extracting the user data from the one or more business data sources by performing at least one of process mining, tasking mining, or task capture to determine how individuals of the organization interact with entities of the organization.

16. The apparatus of claim 11, wherein extracting entity data, process data, user data, and system data of an organization from one or more business data sources comprises:
extracting the system data from the one or more business data sources by performing at least one of process mining or process capture to determine a relationship between systems of the organization and entities of the organization.

17. The apparatus of claim 11, the operations further comprising:
tracking changes of the entity data, the process data, the user data, and the system data; and
updating the knowledge graph based on the tracked changes.

18. The apparatus of claim 11, the operations further comprising:
repeating the extracting, the generating, and the outputting for a plurality of organizations to generate a plurality to knowledge graphs; and
generating an optimized knowledge graph based on the knowledge graph and the plurality of knowledge graphs.

19. The apparatus of claim 18, the operations further comprising:
creating one or more standardized processes for the organization and the plurality of organizations based on the optimized knowledge graph.

20. The apparatus of claim 18, the operations further comprising:
extracting one or more best practices processes from the optimized knowledge graph; and
storing the one or more best practices processes in a library.

21. A non-transitory computer-readable medium storing computer program instructions, the computer program instructions, when executed on at least one processor, cause the at least one processor to perform operations comprising:
extracting entity data, process data, user data, and system data of an organization from one or more business data sources;
generating a knowledge graph defining relationships between the entities data, the process data, the user data, and the system data; and
outputting the knowledge graph.

22. The non-transitory computer-readable medium of claim 21, wherein extracting entity data, process data, user data, and system data of an organization from one or more business data sources comprises:
extracting the entity data from the one or more business data sources by performing semantic meaning extraction of entities of the organization.

23. The non-transitory computer-readable medium of claim 21, wherein extracting entity data, process data, user data, and system data of an organization from one or more business data sources comprises:
extracting the process data from the one or more business data sources by performing at least one of process mining, task mining, task capture, or process capture to identify processes defining how entities of the organization interact with each other.

24. The non-transitory computer-readable medium of claim 23, wherein the processes are RPA (robotic process automation) processes executed at least in part by one or more RPA robots.

25. The non-transitory computer-readable medium of claim 21, wherein extracting entity data, process data, user data, and system data of an organization from one or more business data sources comprises:
extracting the user data from the one or more business data sources by performing at least one of process mining, tasking mining, or task capture to determine how individuals of the organization interact with entities of the organization.

26. The non-transitory computer-readable medium of claim 21, wherein extracting entity data, process data, user data, and system data of an organization from one or more business data sources comprises:
extracting the system data from the one or more business data sources by performing at least one of process mining or process capture to determine a relationship between systems of the organization and entities of the organization.

27. The non-transitory computer-readable medium of claim 21, the operations further comprising:
tracking changes of the entity data, the process data, the user data, and the system data; and
updating the knowledge graph based on the tracked changes.

28. The non-transitory computer-readable medium of claim 21, the operations further comprising:
repeating the extracting, the generating, and the outputting for a plurality of organizations to generate a plurality to knowledge graphs; and
generating an optimized knowledge graph based on the knowledge graph and the plurality of knowledge graphs.

29. The non-transitory computer-readable medium of claim 28, the operations further comprising:
creating one or more standardized processes for the organization and the plurality of organizations based on the optimized knowledge graph.

30. The non-transitory computer-readable medium of claim 28, the operations the operations further comprising:
extracting one or more best practices processes from the optimized knowledge graph; and
storing the one or more best practices processes in a library.
